(19) United States
(12) Patent Application Publication
(10) Pub. No.: US 2008/0303661 A1
(43) Pub. Date: Dec. 11, 2008

(54) COMPACT AND SELF-CONTAINED SECURITY SYSTEM

(76) Inventor: James S. Chick, Morgan Hill, CA (US)

Correspondence Address: SCHNECK & SCHNECK, P.O. BOX 2-E, SAN JOSE, CA, 95109-0005, US

(21) Appl. No.: 12/134,856

(22) Filed: Jun. 6, 2008

Related U.S. Application Data
(60) Provisional application No. 60/933,518, filed on Jun. 6, 2007.

(51) Int. Cl. G08B 13/00

(52) U.S. Cl. 340/541

(57) ABSTRACT

A system to monitor and detect an intruder within a structure is disclosed. The system comprises a self-contained security insert configured to be mounted to and substantially contained within an electrical junction box. The security insert is capable of being coupled to a primary power source within the structure and operating as a stand-alone security device. The self-contained security insert includes an occupancy sensor configured to detect the intruder, a modem block coupled to the occupancy sensor and configured to transmit one or more intrusion codes to other electrical devices within the structure, a primary lighting control circuit configured to activate an externally mounted lighting device upon detection of the intruder, and a battery backup device contained within the insert and configured to provide power to the insert upon interruption of the primary power source.

### CROSS-REFERENCE TO RELATED APPLICATION

This application claims priority from U.S. Provisional Patent Application Ser. No. 60/933,518 entitled “A Permanently Mounted, Compact, Self-contained Security System with Lighting Automation, Emergency Lighting and Energy Conservation,” filed Jun. 6, 2007 which is hereby incorporated by reference in its entirety.

### TECHNICAL FIELD

The present invention is related generally to security systems. More specifically, the invention is related to security systems that are compact and self-contained.

### BACKGROUND

The traditional security industry was started in the late 1800's. The most notable company in the industry being American District Telegraph, also known as ADT®. Through mergers and acquisitions, ADT® has absorbed many of the security companies of the 1900's and is now the largest electronic-based security company in the United States. The traditional security industry in the United State alone has estimated annual revenues of approximately seven billion dollars. ADT®, as-well-as other smaller companies, has produced thousands of patents during the industry's life-span, far too many to be referenced herein. Key characteristics of modern security systems as they relate to the present invention are discussed below.

Two of the largest residential automated lighting companies are Lutron® and Leviton. Also in the industrial/residential industry is Hubbell, Inc., which is about as old as ADT® with annual revenues of approximately $2.5 billion. Combined, these three companies have been granted over 1,500 patents.

The home automation industry is generally associated with high-end housing and life styles. A primary focus of the industry is to provide structured wiring for convenience, distribution, and remote control of HVAC, entertainment elements such as audio, video, Internet, programmable lighting, and remote control. The largest integrators and installers include: Home Theater Store, Guardian Home Technologies, and Audio Command Systems. Crossing into the security industry is Home Automation, Inc. (HAI). In the United States, this industry has an estimated annual revenue of approximately $700 Million. As these companies are mostly geared to deployment rather than development, the number of patent applications is hard to find but is likely far less than the aforementioned industries.

Additionally, there is an emerging industry referred to as self-monitoring. Self-monitoring has similarities to both the traditional alarm and the home automation industries. However, unlike the traditional alarm companies with tens of millions of deployed systems which rely on low bandwidth plain old telephone service (POTS) communications, this industry requires broadband Internet connectivity so as to provide a customer with large amounts of information such as video monitoring and remote control of appliances, lighting, and HVAC. However, though the content and control aspects are improved, many elements such as emergency services are not available without the users directly calling a third-party agency. Further, power failures generally render the system inoperable and loss of Internet connectivity (including power failure) renders the remote self-monitoring inoperable. Notable companies in this space include Xanboo (AT&T Remote Monitoring and Motorola Homesite), iControl, and Wilife. The numbers of patents held by companies within this industry are few.

Today's electronic security systems have several basic characteristics. First they all have an alarm panel. The alarm panel is often concealed in a metal box and located in an unobvious location so as to prevent an intruder from compromising security by disabling the panel. This device serves as the brain of the system, taking its commands from control devices for arming and disarming, and monitors various sensors to detect an intrusion or other emergency situation. Optionally, the alarm panel may annunciate alarm conditions with audible devices such as beepers or sirens and visual devices such as lighting, both of which are intended to deter an intruder and draw attention from anyone in the vicinity. Further, the alarm panel may relay information to professional monitoring centers which will summon emergency services and notify users of a breach in security. A typical system relies on POTS primarily since it has been around since the late 1800's. Only within the last few years has the emergence of broadband Internet connectivity become prevalent leaving the industry in a dilemma associated with a paradigm shift as their deployed POTS based systems cease to function in homes and businesses that convert to an Internet-only environment.

When considering detection devices, there are many means employed, with the three most common being: (1) simple switches used to detect opening of doors and windows; (2) motion detectors based on passive infra-red (PIR) and ultrasonic technologies; and (3) glass breakage detectors. Contemporary alarm system sensors are interconnected to the alarm panel by one of two means. They are either hardwired directly to the alarm panel, or send a radio-frequency (RF) signal to a receiver associated with the alarm panel. Both of these signal means has advantages and disadvantages.

Hardwired sensors and annunciators have advantages in being lower in cost since they are not equipped with an RF transmitter, rely on a single uninterruptible rechargeable power source centrally located within the alarm panel housing, and can readily be continuously supervised for wiring and sensor failure. However, hardwired sensors and annunciators have a disadvantage due to a high cost of installation associated with installing cable runs between the panel, sensors, and annunciators.

Wireless sensors and annunciators have an advantage due to a lowered cost of installation since sensors can be simply affixed to almost any desired location, usually with no more effort than hanging a picture. However, the wireless sensors and annunciators have several disadvantages related to a higher cost to incorporate additional RF signaling circuitry in addition to the cost of the sensor, relying on distributed non-rechargeable battery power subject to security failure and requiring routine service to replace batteries, an inability to be continuously monitored for failure due to both FCC regulations and battery life, and having a range limited by FCC power limit regulations and effects due the environment (walls, etc.) thus limiting distance from and reliability of signals to the alarm panel.

Hybrid wired and wireless combination alarm systems are available. However, the hybrid systems do not mitigate the disadvantages cited above associated with either type of sensor or annunciator.

Widely available for many years have been lighting systems for both indoor and outdoor usage where associated lighting is turned on when a built-in sensor (usually a PIR) detects the presence of someone during a low ambient lighting condition. Generally known as occupancy sensors, usage to control inside lighting is widespread and is increasing. These commonly available and inexpensive devices have grown in popularity as both an energy savings device and for convenience. However these inexpensive interior occupancy sensors become non-functional when main power is lost (which is unimportant in this context since there is generally no power for the light being controlled). Known in prior art are occupancy sensors that contain backup battery and lighting for operation when there is a primary main power outage. However, these systems are not known to provide lighting control under remote control.

New industries have entered the marketplace to provide home automation and typically include functionality for automated lighting control. Lighting throughout an entire dwelling is altered depending on a user predefined scenario. The home automation arena also provides automatic and remote control of audio, video, Internet, HVAC, and security-related functions. However, during a power outage, there is no practical application for dynamic remote control of a lighting system when there is no power for the light.

Some traditional alarm systems also have provisions to activate a dwelling's lights, but as with traditional occupancy detectors, home automation and self-monitoring systems, they too become non-functional during a power outage, even though the security system is active. Typically, security systems provide an optional interface to off-the-shelf third-party devices such as those offered by X-10, a wireless and wired powerline communication technology.

In contrast to the characteristics of various lighting schemes described above is emergency lighting. For many years, there have been mandated laws to provide emergency lighting in the event of power failure (e.g., public places must have battery operated exit signs). During a power failure the light will operate for a period of time dependant on battery capacity and the energy requirements of the light. However, such devices are not remotely controllable nor do they possess power savings characteristics to extend the operational time during a power outage.

Therefore, what is needed is a means to simply and economically provide a security system which is readily adaptable to a given environment, compact, provides operation independently of a primary power source, and provides safety lighting independently of a primary power source.

### SUMMARY

In an exemplary embodiment, a system to monitor and detect an intruder within a structure is disclosed. The system comprises a self-contained security insert configured to be mounted to and substantially contained within an electrical junction box. The security insert is capable of being coupled to a primary power source within the structure and operating as a stand-alone security device. The self-contained security insert includes an occupancy sensor configured to detect the intruder, a communication block coupled to the occupancy sensor and configured to transmit an intrusion signal, a primary lighting control circuit configured to activate an externally mounted lighting device upon detection of the intruder, and a battery backup device contained within the insert and configured to provide power to the insert upon interruption of the primary power source.

In another exemplary embodiment, a system to monitor and detect an intruder within a structure is disclosed. The system comprises a self-contained security insert configured to be mounted to and substantially contained within an electrical junction box. The security insert is capable of being coupled to a primary power source within the structure and operating as a stand-alone security device. The self-contained security insert includes an occupancy sensor configured to detect the intruder, a modem block coupled to the occupancy sensor and having a first radio-frequency transmitter operable at a first frequency and a second radio-frequency transmitter operable at a second frequency. The modem block is configured to transmit one or more intrusion codes to other electrical devices within the structure. A primary lighting control circuit is configured to activate an externally mounted lighting device upon detection of the intruder, an annunciator configured to provide an audible signal upon detection of the intruder, and a battery backup device is contained within the insert and configured to provide power to the insert upon interruption of the primary power source.

In another exemplary embodiment, a system for monitoring and detecting an intruder within a structure is disclosed. The system comprises a self-contained security insert configured to be mounted to and substantially contained within a single-gang electrical junction box. The security insert is capable of being coupled to a primary power source within the structure and operating as a stand-alone security device. The self-contained security insert includes a sensor means for detecting the intruder, a transmission means for transmitting one or more intrusion codes to other electrical devices within the structure, a lighting means for activating an externally mounted lighting device upon detection of the intruder, an annunciator means for providing an audible signal upon detection of the intruder, and a backup means contained within the insert for providing power to the insert upon interruption of the primary power source.

### BRIEF DESCRIPTION OF THE DRAWINGS

The appended drawings merely illustrate exemplary embodiments of the present invention and must not be considered as limiting its scope.

FIG. 1A is an exemplary embodiment of a security system of the present invention mounted in a single-gang junction box.

FIG. 1B is the security system of FIG. 1A arranged with alternative cover plates to physically provide additional space as needed to house various components.

FIG. 2A is an isometric view of an exemplary embodiment of the security system of FIG. 1A arranged in a single-gang junction box capable of accommodating additional electrical high-voltage devices or low-voltage devices.

FIG. 2B is a top-view of an alternate arrangement of the security system of FIG. 1A arranged in a single-gang junction box.

FIG. 2C is a side elevational view of an alternate arrangement of the security system of FIG. 1A arranged in a single-gang junction box.

FIG. 2D is an isometric view of an exemplary embodiment of the security system of FIG. 1A arranged in a modified double-gang junction box capable of accommodating additional electrical high-voltage devices or low-voltage devices.

FIG. 3 is a block-diagram of circuitry interconnections of an exemplary embodiment of a security system of the present invention.

FIG. 4 is a detailed block-diagram of communication and electrical pathways of the security system of FIG. 3.

FIGS. 5A and 5B comprise a detailed schematic of radio-frequency (RF) and power-line carrier (PLC) communication integrated circuits used in various embodiments of the present invention.

### DETAILED DESCRIPTION

A stand-alone security device is described in various exemplary embodiments described herein. The device may incorporate a combination of a tamper resistant security system, an occupancy lighting control system, an intruder deterrent system, and an extended emergency lighting system. Additionally, power conservation circuitry is provided even in the event of an outage of external AC-based power. The device is installed into either an existing or newly installed junction box as commonly employed for light switches and electrical outlets. Therefore, especially in the case of an existing junction box, the device is simple to install. The combination of one or more of the aforementioned systems into a single package overcomes issues facing multiple industries including security, home automation, and safety industries by providing more functionality, simple installation, increased reliability, and flexibility within a single compact device.

The present invention is also configured to adhere to basic security and safety standards such as Underwriters Laboratory (UL), National Fire Prevention Association (NFPA), and the Security Industry Association (SIA). Moreover, various embodiments of the security device presented herein provide expansion capabilities from single area protection to protection of multiple areas via radio frequency (RF) or power line carrier (PLC) communications between the units in each of the areas. Further, operation during a primary power failure is ensured by a built-in uninterruptable power supply.

Additional features of the present invention include options allowing, for example, standalone emergency services such as emergency lighting, audible warnings, energy saving by controlling lighting based on occupancy, open system support for automation functionality, support for a plurality of communications protocols and their associated physical and electrical interfaces requirements, and a variety of gateway services between remote devices and local devices. Each of these features is described in detail below.

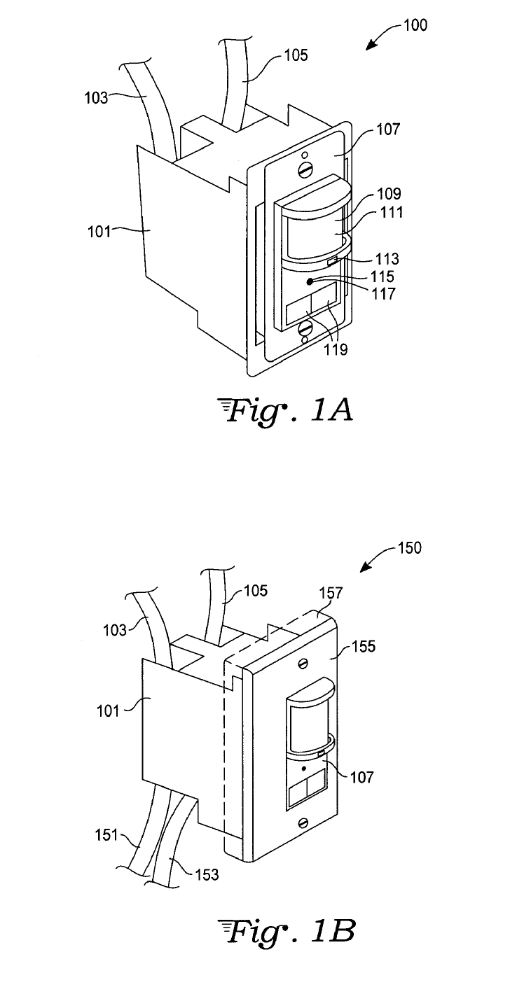

With reference to FIG. 1A, an exemplary embodiment of a partially installed security system 100 includes an existing or installed junction box 101, an existing or installed power cable 103, and an optional additional circuit cable 105. The power cable 103 provides AC-based power at, for example, nominally 120 volts (in the United States). The additional circuit cable 105 may be a continuation of the AC-based power supply feed or a switch loop to an external lighting fixture (not shown).

An exemplary security system insert 107 includes a light level sensor 109, an occupancy sensor 111, a secondary lighting source 113, an audible annunciator 115, an audible events sensor 117, and manual actuators 119. A skilled artisan will recognize that each of these elements is known individually in the art and may be physically rearranged on the security system insert 107. The skilled artisan will further recognize that each of the elements described with reference to FIG. 1A are merely features. Therefore, not all elements shown need to be included as a portion of the exemplary security system insert 107. Generally, the exemplary security system insert 107 is designed to fit substantially within the confines of a junction box 101.

The light level sensor 109 and the occupancy sensor 111 may be located behind a common transparent or translucent cover. The secondary lighting source 113 may be, for example, a small high intensity light capable of providing some level of illumination in case of as primary power failure. The audible annunciator 115 and the audible events sensor 117 may be comprised of a high-intensity speaker and a microphone, respectively, and may be co-located (e.g., either side-by-side, coaxially mounted, or as a single speaker wherein sound is duplexed between listening and annunciating) behind an orifice on the security system insert 107. The manual actuators 119 may be used as a simple switch for one or more lighting fixtures (not shown).

Referring now to FIG. 1B, an installed security system 150 includes a faceplate 155. The faceplate 155 may be a standard Decora® faceplate known in the art and is suitable for most installations. However, the wiring actually joined within the junction box 101 often includes wiring for purposes other than lighting. For example, a first 151 and a second 153 cable may supply additional AC-based power to additional branch circuits (not shown) such as lighting and electrical outlets.

The National Electrical Code (NEC) sets regulations for a minimum junction box volume based upon factors such as the number of wires entering or leaving a junction box, the number of devices within the box, and the gauge of the wires. Thus, a particular junction box may require additional volume to comply with NEC regulations. Thus, an existing junction box may lack sufficient volume for some exemplary embodiments of the present invention. To overcome this issue, an optional extended faceplate 157 can be used protruding from the junction box and thus providing additional volume.

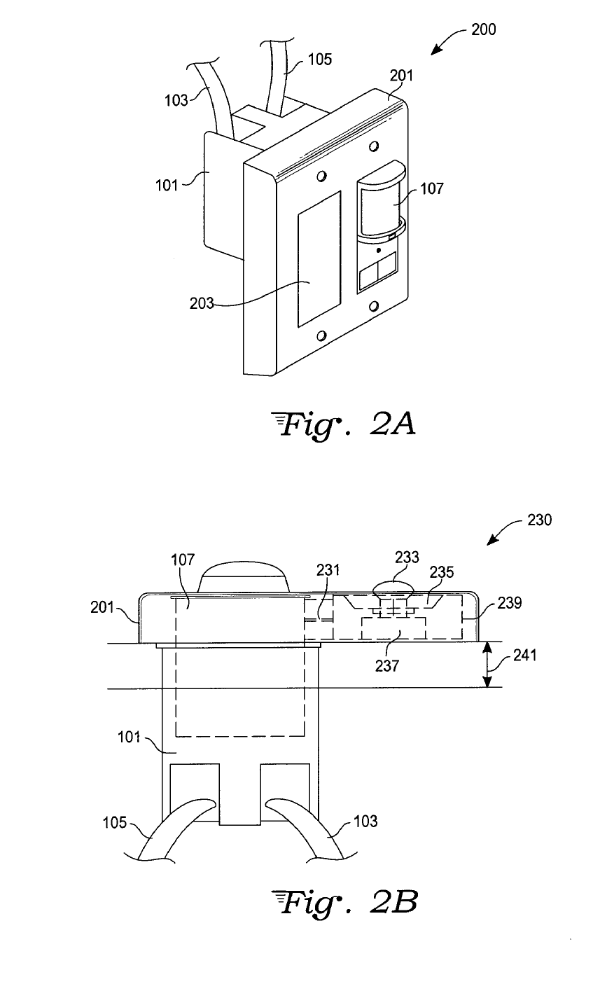

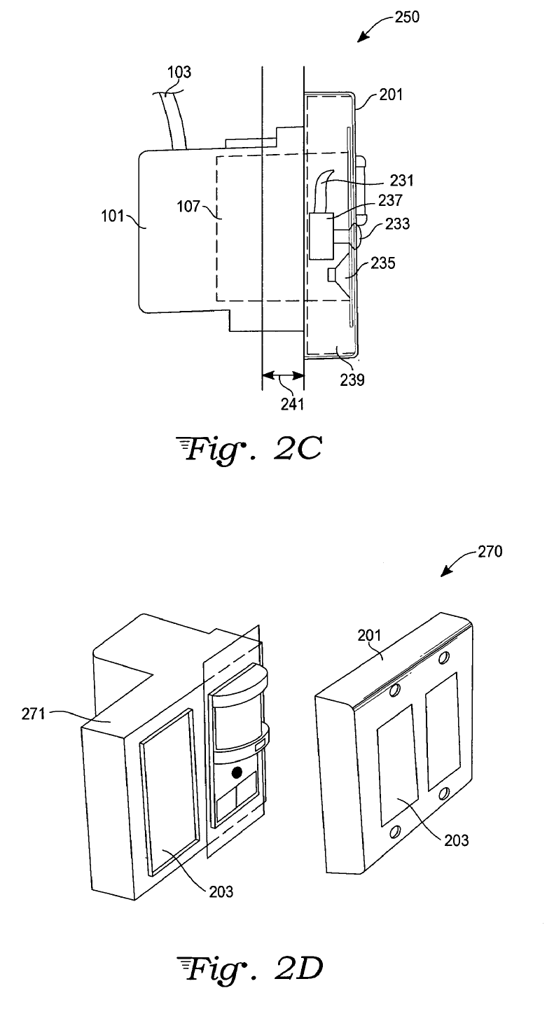

In FIG. 2A, an extended installed security system 200 includes an extended oversized faceplate 201 providing additional volume plus an additional opening 203. The extended oversized faceplate 201 may also be used over a double-gang junction box (not shown). The additional opening 203 may be used for low-voltage applications such as phone lines, twisted pair cabling (e.g., such as CAT 6E cables for Internet or CCTV connectivity). Alternatively, if a double-gang junction box is employed, the additional opening 203 may be used to house additional high-voltage (e.g., 120 volt) devices as well. Further, the additional opening 203 may be used for placement of additional elements, described below.

FIG. 2B is a top view of an alternative arrangement 230 of the extended installed security system 200 of FIG. 2B showing the exemplary security system insert 107 mounted in relation to a wall 241. The top view 230 includes additional optional components such as a secondary electronics enclosure 239 which, for this exemplary embodiment, provides a housing for a speaker 237, a camera 233, additional electronic support circuitry 237, and an electrical interconnection 231 to augment features of the exemplary security system insert 107. The additional electronic support circuitry 237 is described in more detail below. Each of the additional elements is independently known in the art

FIG. 2C provides a side elevational view 250 of the alternative arrangement 230 of FIG. 2B. The side elevational view provides additional clarity of alternative arrangements of the present invention to one of skill in the art.

Referring now to FIG. 2D, an isometric view 270 includes the extended oversized faceplate 201 and a modified double-gang junction box 271 to accommodate various types of circuitry. For example, the shallower side of the modified double-gang junction box 271 may be used for a variety of security system peripheral devices or expansion devices (discussed in more detail, below). Both high-voltage and low-voltage devices may be placed in the shallower portion (as is known in the art, an internal divider may need to be added between high and low-voltage sides if so used). As will be recognized by a skilled artisan, additional physical configurations covering form, fit, and function can be realized in various combinations of the enclosures described herein.

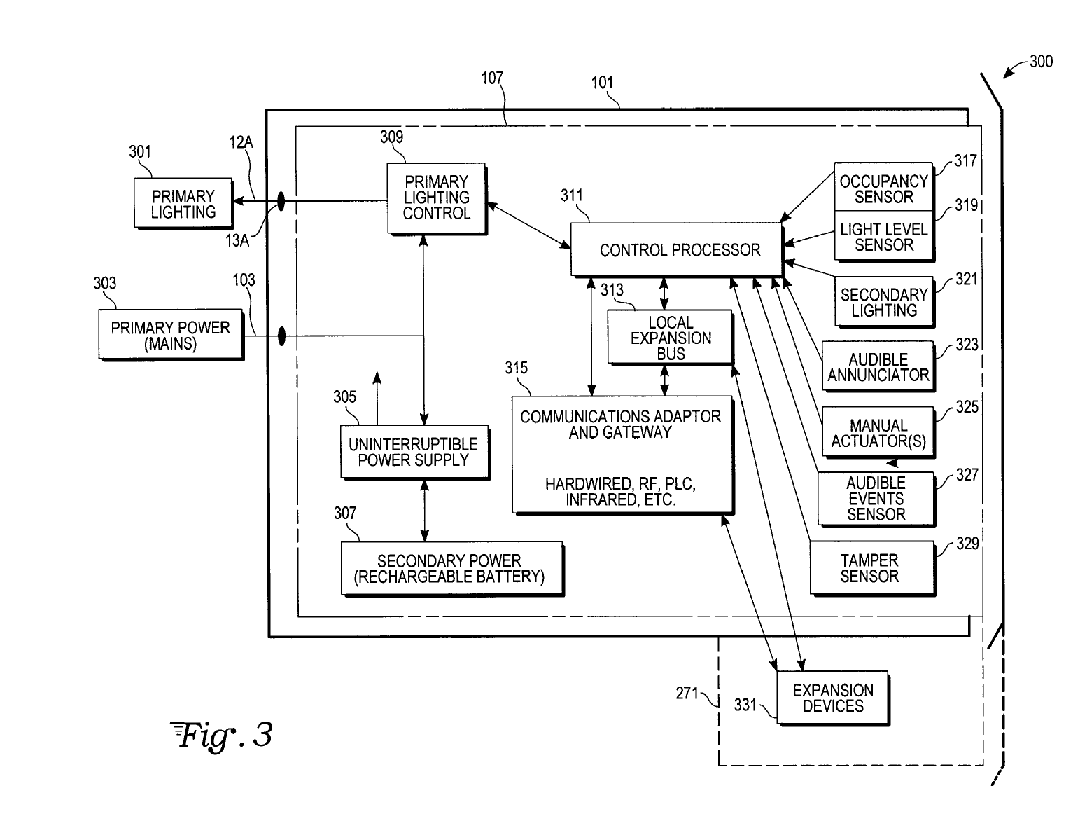

With reference now to FIG. 3, a block-diagram 300 of an exemplary embodiment of the exemplary security system insert 107 mounted within a junction box 101 includes a control processor 311 to provide primary logic, memory, monitoring, and control of the exemplary security system. The control processor 311 monitors input conditions and controls output states of various embodiments of the present invention. A security latching mechanism may be employed to retain any history of security-related events in a non-volatile memory (not shown) associated with the control processor 311. A record of such events may be maintained until such time that they are acknowledged by a local user and/or a remote device.

The control processor 311 is discussed in more detail below but generally may be comprised of a general purpose microprocessor or microcontroller, both of which are known independently in the art. Additionally, the control processor 311 may be implemented as in a system-on-chip (SOC) design. Common within SOC designs are a central processing unit, volatile and non-volatile memory, dedicated application specific integrated circuitry (ASIC), and code to provide operational rules of the present invention thereby providing all necessary intelligence to operate. Common features in these highly integrated systems are communications interfaces ranging from simple low-speed serial, to high-speed parallel interfaces.

In a specific exemplary embodiment, the control processor 311 is a LPC210X series single chip microcontroller manufactured by Philips Semiconductor (located at 5600 KA Eindhoven, The Netherlands). The LPC210X series single chip microcontroller is a 32-bit microprocessor with an ARM architecture based on reduced instruction set computer (RISC) principles. The microcontroller typically incorporates a 8 kB, 16 kB, or 32 kB flash memory system which may be used for both code and data storage.

The control processor 311 may be electrically coupled to a local expansion bus 313 and a communications adapter and gateway 315. The local expansion bus 313 is an electrical interface that can be used to adapt additional devices to the exemplary security system insert 107, allowing customization of the invention to a variety of needs as required by an end-user.

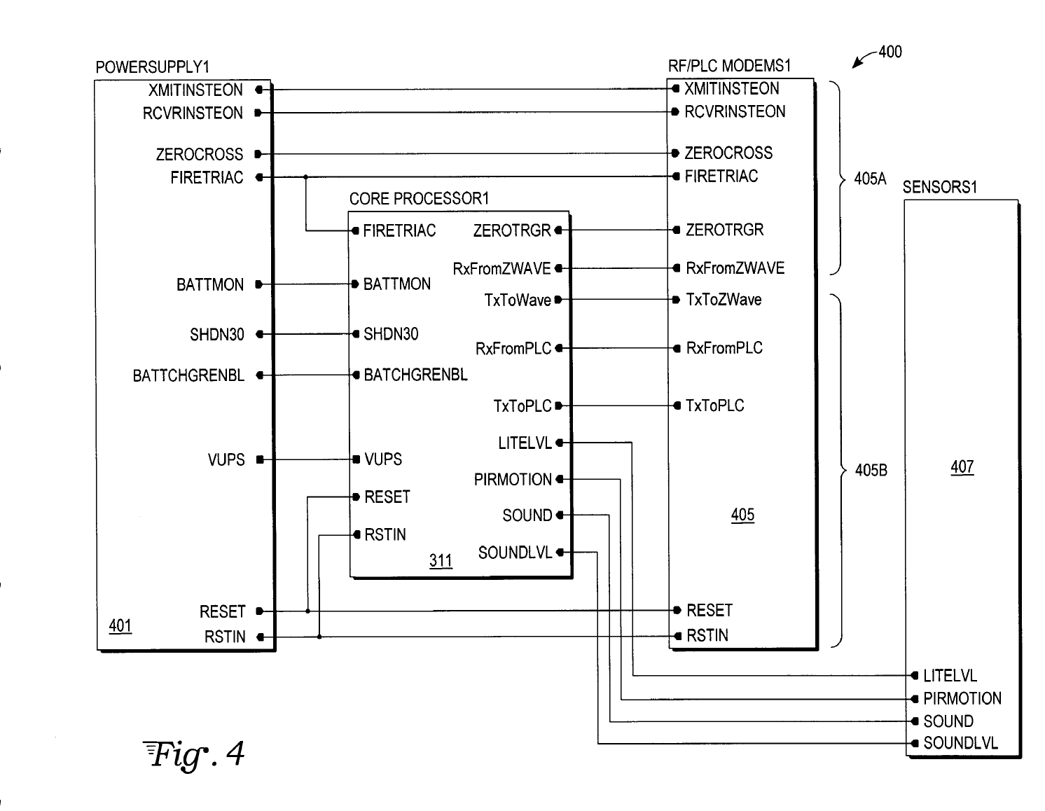

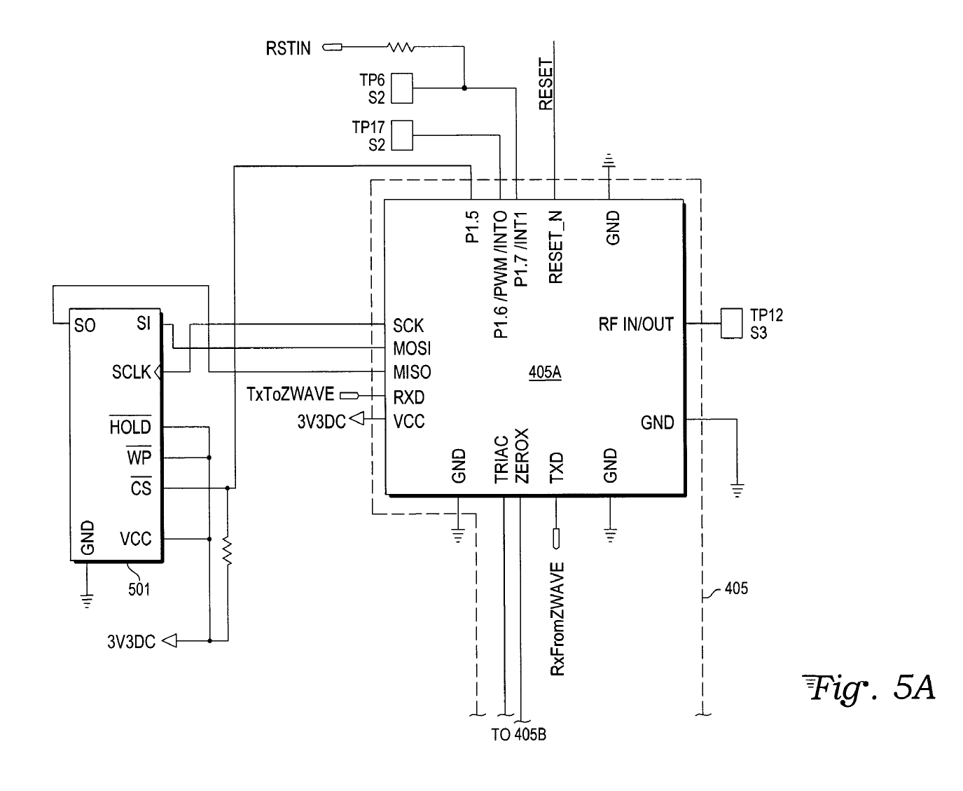

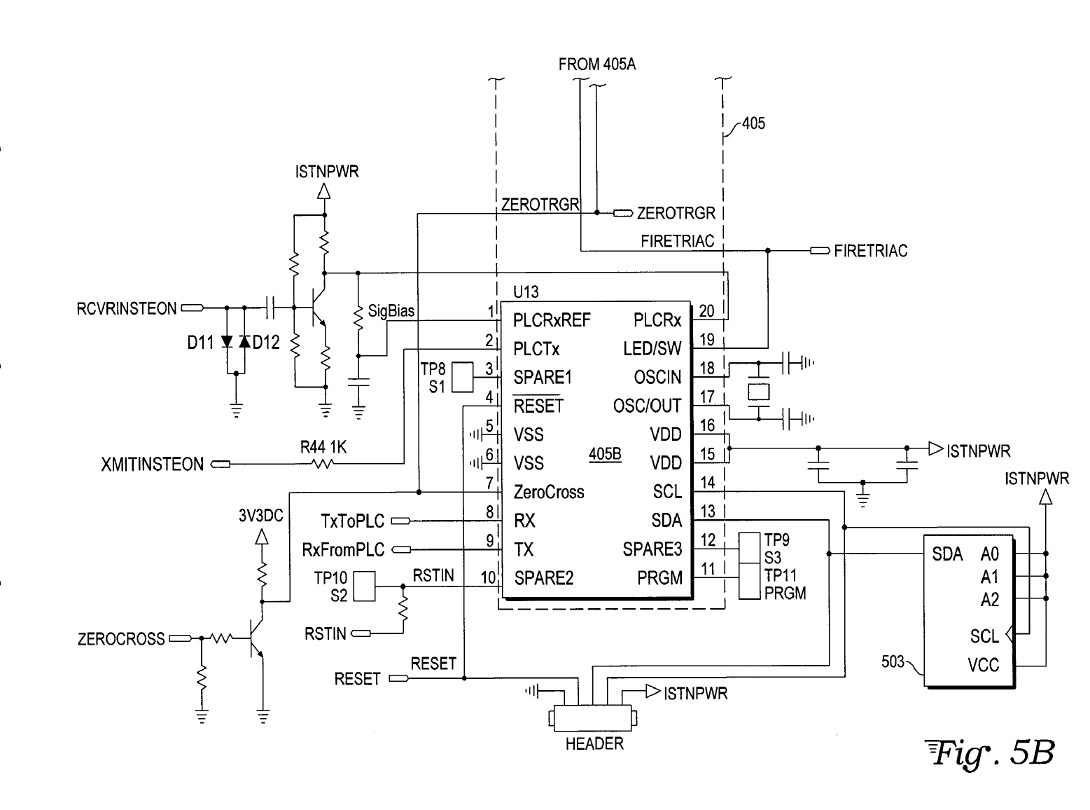

Additionally, the local expansion bus 313 is available to provide an electrical interface in a fashion similar to the communications adapter and gateway 315, as is described briefly immediately below and in more detail with reference to FIGS. 4 and 5. The primary difference between the two interfaces is distance. Whereas the communications adapter and gateway 315 is intended for communications with distant remote devices (not shown but described in detail, below), the local expansion bus 313 is intended to communicate with peripheral devices within relatively short electrical communications ranges. Example devices that may use the local expansion bus 313 include, for example, local loop wiring for hardwired security sensors such as those used to monitor a door or window, additional actuators such as push-buttons, and control and monitoring of electromechanical devices such as relays and optical isolators to prevent an ancillary connection exposure to high-voltage levels associated with a primary power source 303 (e.g., a 120 volt AC-based power supply).

The communications adapter and gateway 315 may be configured to provide a communications link which is passive as when, for example, a PLC interface is employed to provide connectivity to the various security functions. The PLC interface could also act as a gateway to provide direct access to an expansion device, such as a digital video camera housed within the exemplary security system insert, wherein secondary access does not affect operational characteristics of the present invention. Generally, the communications adaptor and gateway 315 provides an interface for remote monitoring and control services, both of which are explained in detail with reference to FIGS. 4 and 5, below. In other embodiments, the communications adaptor and gateway 315 is a simpler communications device which may couple one or more expansion devices 331 (described below) or other internal devices such as an audible annunciator 323 (also described below) to the exemplary security system insert 107 by hardwired connections, IR communications, audible communications, or a host of other communications means known independently in the art.

The principles employed are those similar to those used within computer architecture known as Direct Memory Access (DMA) wherein information is transferred to and from a peripheral device and memory associated with a central processing unit (CPU) without the intervention of the CPU. In this scenario, the remote communications devices share a local expansion device but the remote communications with the target device do not interact with core functionality of the present invention. However, remote access directly to an expansion device does not preclude the present invention from communicating with the expansion device as well.

The control processor 311 may accept a number of inputs from, for example, an occupancy sensor 317 to determine of human motion is detected and a light level sensor 319 to measure ambient light level within an adjoining space to determine if emergency lighting is needed. An operational rule within the control processor 311 may be configured to enable primary lighting (not shown) when motion is detected within the monitored adjacent area and ambient light, as detected by the light level sensor 319 is below a pre-defined level. Further, the control processor 311 may be configured to maintain the primary lighting on for a pre-defined period after cessation of any detected motion.

If a determination is made that emergency lighting is needed, a secondary lighting circuit 321 may be activated. The secondary lighting circuit 321 may be self-contained as, for example, a small high-intensity light contained within the exemplary security system insert 107. Additionally, the secondary lighting circuit 321 may be a general purpose visual indicator showing location or activation level of the exemplary security system insert 107. In other embodiments, the secondary lighting circuit 321 may be a super-bright multicolored light emitting diode (LED) capable of providing sufficient ambient light during a primary power outage.

Also, differently colored illumination sources may be used to provide color coded annunciation, such as red with fire/smoke, green when disarmed, yellow during entry/exit delay periods, and white during emergency lighting. If the primary power source 303 fails, power for the secondary lighting circuit 321 may be supplied by an uninterruptible power supply 305. Therefore, emergency lighting is provided and the battery life is extended since the lighting is turned on only when needed to illuminate the occupied area. A unique advantage of this combination of sensor and logic is a reduction in physical space requirements needed during emergency lighting operation as a smaller battery can be used since the secondary lighting circuit 321 (i.e., emergency lighting) is not continuously operational. Further, on-demand emergency lighting can be sustained for a period exceeding a standard always-on lighting system when having an equivalent battery capacity and light power requirements as incorporated herein.

The audible annunciator 323 provides an audible warning if either an intruder is detected within the adjoining space or if a tamper sensor 329, which provides an indication associated with attempts to compromise the system, has been activated. The tamper sensor 329 may, for example, physically monitor faceplate removal. Activation of the tamper sensor 329 is considered a security event and is therefore logged within the security latching mechanism, described above. Additionally, activation of the tamper sensor 329 may optionally cause a disconnection from the primary power source 303, thereby providing safety for service personnel.

The audible annunciator 323 is capable of, for example, providing audible sounds for feedback, warnings, and deterrent indications. Additionally, when an optional audible event sensor 327 (described below) and a remote audible annunciator (not shown) are used with two separate instantiations of the present invention and are within a suitable range so as to be able to establish an acoustical link, communications can be established to share information such as arm, disarm, and intrusion detection. The information could be relayed by coded messages in a fashion similar to Morse Code.

The optional audible event sensor 327 may operate in conjunction with the control processor 311. Audible monitoring may be combined with other sensor types (not shown but known in the art) to provide for a variety of related sensing applications such as glass breakage, smoke/heat detector activation, carbon dioxide (CO₂) sensor activation, sound recordings, door bells, ringing phones, and loud noises. When any these events occur, the present invention may log and annunciate detection by activation of one or more of its output devices.

One or more manual actuators 325 provide a manual means for an operator to control, for example, functionality of features of the exemplary security system insert 107 or control an electrically coupled lighting fixture (not shown). The one or more manual actuators 325 may control one or more lights whose primary wiring is within the junction box 101 in which the exemplary security system insert 107 is installed, even though the one or more lights may not necessarily be controlled by the present invention.

An audible event sensor 327 allows the exemplary security system insert 107 to audibly monitor an adjoining environment. The one or more manual actuators 325 provide a mechanism for controlling various functions of the present invention. The one or more manual actuators 325 may be comprised of at least a single push-button or toggle switch, but may contain a plurality of buttons such as a full alpha-numeric keypad (not shown but known in the art). In conjunction with the control processor 311, the one or more manual actuators 325 may also provide a mechanism to command various functions of the invention. Complex functionality such as arming, disarming, and light-dimmer control may be generated by increasingly more complex sequences requiring variations in button selection and/or activation including variance of press duration and cadence. Programming of such sequences is known in the art.

Additionally, the one or more expansion devices 331 may be contained in a space adjacent to the junction box 101, such as in the modified double-gang junction box 271 (see also, FIG. 2D). The one or more expansion devices 331 may be either electrically coupled or otherwise in electrical communication with the communications adaptor and gateway 315 or the local expansion bus 313. As is recognizable to a skilled artisan, the one or more expansion devices 331 may include devices commonly used in the automation, lighting, and security industries.

Expansion devices may also include any device that is deemed useful for an end-user such as an ability to provide an imaging device to capture visual records. Thus, exemplary embodiments of the present invention provide an ability to coordinate an imaging device to the occupancy sensor 317 and activation of lighting through, for example, a primary lighting control circuit 309. With on-demand lighting available, whether it is from the primary 309 or secondary lighting circuit 321, a lower-cost less-sensitive camera can be used rather than higher-cost low-light camera technology.

Additionally, operational life is extended when the primary power source 303 is unavailable since power for lighting and camera operations is only activated when required. Versatility is further enhanced by providing access to the camera from a remote location through the use of the gateway functionality of the communications adapter and gateway 315. Stealth operations can be realized when, for example, one of the one or more expansion devices 331 uses an on-demand infrared lighting source and infrared capable camera (neither of which is shown).

Further, the one or more expansion devices 331 may provide user recognition based on biometric data such as, for example, a fingerprint reader or voice recognition which can be used to arm, disarm, and unlock and control functions within the present invention.

With continued reference to FIG. 3, the left-side of the block-diagram 300 includes a interconnection 13A via existing wiring 12A to a primary lighting circuit 301, the primary lighting control circuit 309, discussed above, to provide a mechanism to set an activation state of associated lighting fixtures (not shown), and an uninterruptible power supply (UPS) 305 which provides a centralized power source should the primary power source 303 fail. Additionally, the secondary power source 307 supplies energy to the device in the absence of the primary power source 303. The secondary power source 307 may be provided by one or more rechargeable batteries.

Referring now to FIG. 4, a more detailed block diagram 400 of communication and electrical pathways of FIG. 3 includes a power supply block 401, an RF/PLC modem block 405, and a sensor block 407. Details of typical regulated power supplies and power supplies in general are well-known in the art and will not be considered further herein.

As described with reference to FIG. 3, above, the communications adaptor and gateway 315 is coupled to the control processor 311. The present invention contains at least one communications interface to permit factory or field programmability of either memory contained within the control processor 311 or external memory (not shown) coupled to the control processor 311. By modifying any programmable memory associated with the control processor 311, feature upgrades, repair of faulty application code, setting unique identity, diagnostics, customization of operation, and so on may be achieved.

The communications adaptor and gateway 315 contains the RF/PLC modem block 405. The RF/PLC modem block 405 is configured to operate on one or more protocols, physical and electrical interface(s) such as USB, RS-232, Power Line Carrier, RF Receiver and/or RF Transmitter, Infrared, Ethernet, hardwired, or any future interface suitable for communications with this invention. Additionally, the communications interface may be passive with respect to various operational features thereby serving as a a portal between remote devices including disciplines from within other industries and devices associated with physical proximity of the invention or within range of detectors.

As noted above, various embodiments of the present invention describe a self-contained device configured to operate autonomously and therefore not require a network communication connection to function. However, such a link is provided so as to expand the usefulness when used in conjunction with automation, control, monitoring, security systems, or any system whose functionality is enhanced by accessing various features of the present invention.

With reference to a specific exemplary embodiment of FIG. 4, the RF/PLC modem block 405 includes two main components, an RF integrated circuit portion 405A and an RF/PLC integrated circuit portion 405B. In this embodiment, both the RF integrated circuit portion 405A and an RF/PLC integrated circuit portion 405B of the RF/PLC modem block 405 utilize a narrowband frequency-shift-keying (FSK) on-board radio transmitter operating at two unique frequencies.

Just as the audible event sensor 327 (FIG. 3) may be configured to monitor other autonomous devices that are coupled by only an acoustic median (e.g., compression and rarefaction of ambient air), the RF/PLC modem block 405 supporting the RF integrated circuit portion 405A can monitor autonomous wireless devices coupled by only radiated RF energy. When used in conjunction with other optional adaptors such as the power line carrier (PLC), the distance of a wireless sensor from a master control panel can be increased by relaying wireless sensor status through the RF/PLC integrated circuit portion 405B. Additionally wireless devices such as key fobs or other remote RF devices can be used to arm, disarm, and provide general remote control of various embodiments of the present invention. More details on both the RF integrated circuit portion 405A and the RF/PLC integrated circuit portion 405B are described in more detail with reference to FIGS. 5A and 5B, below.

When the RF/PLC modem block 405 includes an RF transmitter, any status information may be transmitted to other instantiations of the present invention deployed elsewhere within a dwelling or structure and possibly directly to an associated receiver in an alarm panel, home automation, or self-monitoring central controller (none of which are shown but would be understandable to a skilled artisan). Though capable of operating as an independent, self-contained alarm and lighting system, by providing an RF communications interface, coordinated expansion can be realized within a system of similar nodes, as-well-as providing expansion for transmission paths within various industry disciplines.

The sensor block 407 may contain, for example, various sensor types for monitoring lighting levels, passive infra-red (PIR) detection, overall sound levels (via, e.g., a microphone), and a plurality of other sensor types known independently in the art.

Referring now to FIGS. 5A and 5B, a detailed schematic of radio-frequency (RF) and power-line carrier (PLC) communication integrated circuits used in various embodiments of the present invention includes the RF integrated circuit portion 405A, along with a first optional external EEPROM integrated circuit 501, and the RF/PLC integrated circuit portion 405B, shown with a second optional external EEPROM integrated circuit 503. The detailed schematic of FIGS. 5A and 5B provides complete details to a skilled artisan on a specific exemplary embodiment of interoperability between the two portions of the RF/PLC modem block 405 and functionality with the remainder of the high-level block diagram 300 of FIG. 3 and the more detailed block diagram 400 of FIG. 4.

In a specific exemplary embodiment, the RF integrated circuit portion 405A employs a Z-Wave® ZW0301 integrated circuit manufactured by Zensys A/S (located at Emdrupvej 26, 2100 Copenhagen, Denmark). The Z-Wave® ZW0301 integrated circuit operates at a frequency of approximately 908.42 MHz frequency in the United States (868.42 MHz in Europe). The Z-Wave® integrated circuit series operates as a two-way, wireless mesh network device and incorporates an integrated RF transceiver, an on-board microcontroller, flash memory, and SRAM.

In the specific exemplary embodiment of FIGS. 5A and 5B, the RF/PLC integrated circuit portion 405B employs an INSTEON integrated circuit manufactured by SmartLabs, Inc. (located at 16542 Millikan Avenue, Irvine, Calif., USA 92606). The INSTEON integrated circuit is a security and home/business automation single-chip solution. The INSTEON integrated circuit uses a dual-mesh network communications technology enabling both power line carrier (PLC) and radio-frequency (RF) concurrently. The dual-mesh network functions in a signal-redundant, non-supervised, peer-to-peer manner. Each device in the network receives messages from both the RF and the PLC portion and are capable of repeating the incoming message, thus extending both the range and reliability of the network. The RF portion of the INSTEON integrated circuit chip operates at approximately 903.99 MHz in the United States. The PLC uses a 131.65 kHz carrier synchronized to the AC-based power supply zero crossings. Since they operate at the zero-crossings of the AC-based power supply, the PLC signal is less affected by noise spikes on the AC line.

In the foregoing specification, the present invention has been described with reference to specific embodiments thereof. It will, however, be evident to a skilled artisan that various modifications and changes can be made thereto without departing from the broader spirit and scope of the present invention as set forth in the appended claims.

For example, although a primary distinction of the present invention is in a replacement of existing lighting control switches, it can be mounted in a stand-alone box and supplied with power through a standard power cord from a an electrical power outlet. Such an embodiment could optionally provide an ancillary plug to control one or more traditional lamps or other appliances or devices.

A skilled artisan will readily envision numerous other alternative mounting means and combinations or permutations based on the exemplary embodiments described herein. The alternative means, combinations, and permutations are still included within a scope of the appended claims. A skilled artisan further will recognize other circuit elements which may be used instead of or in addition to circuit components described herein. These and various other embodiments and techniques are all within a scope of the present invention. The specification and drawings are, accordingly, to be regarded in an illustrative rather than a restrictive sense.

What is claimed is:

1. A system to monitor and detect an intruder within a structure, the system comprising:
a self-contained security insert configured to be mounted to and substantially contained within an electrical junction box, the security insert being capable of being coupled to a primary power source within the structure and operating as a stand-alone security device, the self-contained security insert including:
an occupancy sensor configured to detect the intruder;
a communication block coupled to the occupancy sensor and configured to transmit an intrusion signal;
a primary lighting control circuit configured to activate an externally mounted lighting device upon detection of the intruder; and
a battery backup device contained within the insert and configured to provide power to the insert upon interruption of the primary power source.

2. The system of claim 1 wherein the communication block includes a first radio-frequency transmitter configured to operate at a first frequency and wirelessly transmit one or more intrusion codes to other electrical devices within the structure.

3. The system of claim 1 wherein the communication block includes a power line carrier communications block configured to transmit one or more intrusion codes to other electrical devices within the structure via electrical wiring coupled to the primary power source.

4. The system of claim 1 wherein the communication block includes a second radio-frequency transmitter configured to operate at a second frequency and wirelessly transmit one or more intrusion codes to other electrical devices within the structure.

5. The system of claim 1 wherein the insert is configured to provide an audible signal upon detection of the intruder.

6. The system of claim 1 further comprising an imaging device contained within the insert and configured to be activated upon detection of the intruder.

7. The system of claim 1 further comprising a secondary lighting source contained within the insert and configured to be activated upon detection of the intruder.

8. The system of claim 1 wherein the insert is configured to monitor external security sensors.

9. The system of claim 8 wherein the external security sensors are selected from a group consisting of a light level sensor, an audible events sensor, and a tamper sensor.

10. The system of claim 1 further comprising an Internet gateway within the insert and configured to remotely monitor and control the system.

11. The system of claim 1 wherein the self-contained security insert further comprises a local expansion bus configured to electrically communicate with external expansion devices.

12. The system of claim 1 wherein the electrical junction box is a single-gang box.

13. The system of claim 1 wherein the occupancy sensor is a passive infra-red device.

14. The system of claim 1 wherein the occupancy sensor is an ultrasonic device.

15. A system to monitor and detect an intruder within a structure, the system comprising:
a self-contained security insert configured to be mounted to and substantially contained within an electrical junction box, the security insert being capable of being coupled to a primary power source within the structure and operating as a stand-alone security device, the self-contained security insert including:
an occupancy sensor configured to detect the intruder;
a modem block coupled to the occupancy sensor and having a first radio-frequency transmitter operable at a first frequency and a second radio-frequency transmitter operable at a second frequency, the modem block being configured to transmit one or more intrusion codes to other electrical devices within the structure;
a primary lighting control circuit configured to activate an externally mounted lighting device upon detection of the intruder;
an annunciator configured to provide an audible signal upon detection of the intruder; and
a battery backup device contained within the insert and configured to provide power to the insert upon interruption of the primary power source.

16. The system of claim 15 wherein the modem block further includes a power line carrier communications block configured to transmit the one or more intrusion codes to other electrical devices within the structure via electrical wiring coupled to the primary power source.

17. The system of claim 15 further comprising an imaging device contained within the insert and configured to be activated upon detection of the intruder.

18. The system of claim 15 further comprising a secondary lighting source contained within the insert and configured to be activated upon detection of the intruder.

19. The system of claim 15 wherein the insert is configured to monitor external security sensors selected from a group consisting of a light level sensor, an audible events sensor, and a tamper sensor.

20. The system of claim 15 further comprising an Internet gateway within the insert and configured to remotely monitor and control the system.

21. The system of claim 15 wherein the electrical junction box is a single-gang box.

22. A system for monitoring and detecting an intruder within a structure, the system comprising:
a self-contained security insert configured to be mounted to and substantially contained within a single-gang electrical junction box, the security insert being capable of being coupled to a primary power source within the structure and operating as a stand-alone security device, the self-contained security insert including:
a sensor means for detecting the intruder;
a transmission means for transmitting one or more intrusion codes to other electrical devices within the structure;
a lighting means for activating an externally mounted lighting device upon detection of the intruder;
an annunciator means for providing an audible signal upon detection of the intruder; and
a backup means contained within the insert for providing power to the insert upon interruption of the primary power source.

23. The system of claim 22 wherein the transmission means includes a first and a second radio frequency transceiver configured to wirelessly transmit the one or more intrusion codes to other electrical devices within the structure.

24. The system of claim 22 wherein the transmission means includes a power line carrier communications block configured to transmit the one or more intrusion codes to other electrical devices within the structure via electrical wiring coupled to the primary power source.

25. The system of claim 22 further comprising an imaging means for photographing the intruder.
